(19) United States
(12) Patent Application Publication
(10) Pub. No.: US 2024/0340369 A1
(43) Pub. Date: Oct. 10, 2024

(54) METHOD AND SYSTEM FOR TRACKING AND PROVIDING INFORMATION TO EMERGENCY SERVICES

(71) Applicant: Maryann Kilgallon, Orlando, FL (US)

(72) Inventor: Maryann Kilgallon, Orlando, FL (US)

(21) Appl. No.: 18/131,644

(22) Filed: Apr. 6, 2023

(51) Int. Cl. H04M 1/72421; H04M 1/72409

(52) U.S. Cl. CPC H04M 1/72421; H04M 1/724094; H04M 2250/10

(57) ABSTRACT

The device comprises a GPS tracking system, a wireless communication system, and a database for storing personal information of the individuals. The GPS tracking system allows emergency services to track the location of the device and the individual wearing it in the event of an emergency. The wireless communication system enables emergency services to communicate with the individual and provide instructions or ask for additional information. The database stores personal information, such as medical history, allergies, medication, and emergency contacts, which can be accessed by emergency services in case of an emergency.

### 1. BACKGROUND

### Field

The device is related to the safety of individuals. In particular, the device is related to devices that are used to monitor the location of individuals and in the event of an emergency, connect them to emergency services.

### 2. DESCRIPTION OF THE RELATED ART

### Disclosed

The present invention relates to a device that can be used to track individuals and provide vital information to emergency services. This invention is particularly useful for children, adults, and disabled individuals who may require immediate medical attention or assistance and are impaired in some manner with respect to accessing communication devices.

Travelling can be a thrilling experience for children, but it can also pose some safety concerns. Whether it's a trip to a relative's house or a flight across the country, children should be well-prepared and equipped with knowledge and resources to handle any emergency situations that may arise. One important aspect of travelling alone is ensuring immediate access to emergency services.

Parents ideally should ensure that their children know how to contact emergency services, including 911 or local emergency numbers, and that they have access to a phone or a way to contact someone if they need help. It's a good idea to provide children with a list of emergency contacts, including parents, relatives, and close family friends. Children should also know their home address and have a clear understanding of their surroundings, especially if they're travelling to a new place.

Preferably there is a device that is able to easily used by people in the event of an emergency. The device should be able to contact the necessary services in the local community or area as well as those people important family members and friends.

### SUMMARY

Briefly described an aspect of the present disclosure is an emergency system that is adapted to provide immediate contact to emergency services regardless of location.

An aspect of the present disclosure is an emergency system. The emergency system comprising a wearable device, the wearable device comprising; a global positioning system for determining the position of the wearable device; a trigger that is adapted to transmit a signal, the signal comprising at least the position of the wearable device and an identity associated with the wearable device; a monitoring station adapted to receive the transmitted signal, the signal transmitted containing the identity associated with the wearable device; and a database accessible by the monitoring station wherein the database has data related to the identity associated with the wearable device and information related to emergency services located near the position of the wearable device, the database further adapted to contact emergency services in response to the received transmitted signal.

Another aspect of the present disclosure is an emergency device. The emergency comprising a global positioning system for determining the position of the wearable device; and a trigger that is adapted to transmit a signal, the signal comprising at least the position of the wearable device and an identity associated with the wearable device, wherein when the signal is received by a monitoring station adapted to receive the transmitted signal, a database is accessed by the monitoring station wherein the database has data related to the identity associated with the wearable device and information related to emergency services located near the position of the wearable device, the database further adapted to contact emergency services in response to the received transmitted signal.

### BRIEF DESCRIPTION OF THE DRAWINGS

FIG. 1 shows a view of the wearable device.

FIG. 2 is a diagram of a system that implements the wearable device.

### DETAILED DESCRIPTION

To facilitate an understanding of embodiments, principles, and features of the present disclosure, they are disclosed hereinafter with reference to implementation in illustrative embodiments. Embodiments of the present disclosure, however, are not limited to use in the described systems or methods and may be utilized in other systems and methods as will be understood by those skilled in the art.

The components described hereinafter as making up the various embodiments are intended to be illustrative and not restrictive. Many suitable components that would perform the same or a similar function as the components described herein are intended to be embraced within the scope of embodiments of the present disclosure.

The device comprises a GPS tracking system, a wireless communication system, and a database for storing personal information of the individuals. The GPS tracking system allows emergency services to track the location of the device and the individual wearing it in the event of an emergency. The wireless communication system enables emergency services to communicate with the individual and provide instructions or ask for additional information. The database stores personal information, such as medical history, allergies, medication, and emergency contacts, which can be accessed by emergency services in case of an emergency.

The device is small and can be worn on the wrist, ankle, or attached to clothing. In an embodiment, the device is waterproof, shockproof, and tamper-resistant to ensure it remains operational in various environments and situations.

The GPS tracking system uses satellite technology to track the location of the device and the individual wearing it. The system can also be configured to send alerts to emergency services if the individual moves outside a predetermined area, such as a school or home.

The wireless communication system enables two-way communication between emergency services and the individual wearing the device. The system can use cellular or satellite technology, depending on the availability of network coverage. Emergency services can use the communication system to provide instructions to the individual or ask for additional information, such as the individual's current condition or the location of the emergency. Emergency services can also be dispatched to an area where the individual is based on the information retrieved and accessed by the system.

In an embodiment, the system has a database that stores personal information of the individual wearing the device. The information can be entered by the individual or a caregiver and can include medical history, allergies, medication, and emergency contacts. The database is encrypted to ensure the information remains secure and can only be accessed by authorized personnel, such as emergency services.

In an embodiment, the device can also be programmed to send alerts to emergency contacts, such as family members or caregivers, in case of an emergency. The alerts can be sent via text message, email, or a mobile app.

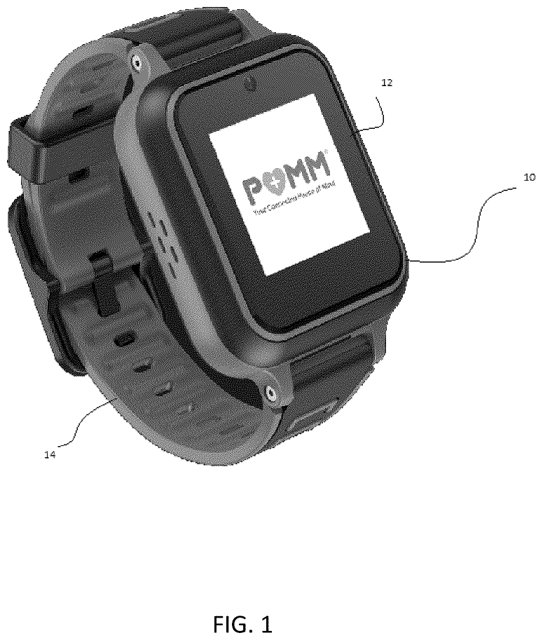

Turning to the figures, wherein like numerals refer to similar components throughout the drawings and specification. Shown in FIG. 1 is a view of the wearable device 10. The wearable device 10 has a has screen 12 and a band 14. The wearable device 10 may be a smart watch, or other wearable device that has electronic communications enabled.

In an embodiment, the wearable device 10 has an interactive button or symbol on the screen that functions as a trigger. Contacting the trigger can transmit a signal. The signal that is transmitted may have positioning information that is gathered from global positioning system information that is stored on the wearable device. The signal that is transmitted from the device may further be associated with the identity of the person who is using the wearable device 10.

It is contemplated that the user of the wearable device 10 is someone who may especially be in need of using such a device. In an embodiment, the user of the wearable device 10 may be a child that is travelling. In an embodiment, the user of the wearable device 10 may be an adult that is travelling. In an embodiment, the user of the wearable device 10 may be an elderly person that is travelling. In an embodiment, the user of the wearable device 10 may be a person that may need assistance, whether travelling or at home for a variety of reasons.

In an embodiment, the wearable device 10 is a watch device. In an embodiment, the wearable device 10 is a necklace. In an embodiment, the wearable device 10 is a fob. In an embodiment, the wearable device 10 is an article of clothing. In an embodiment, the wearable device 10 is located within a toy or other item that is carried or placed within a backpack or article of luggage.

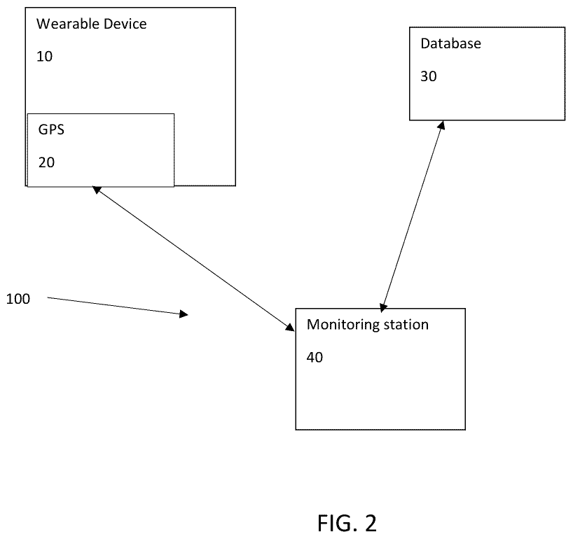

FIG. 2 shows a diagram of the emergency system 100. The emergency system includes GPS 20 that is located within the wearable device 10. While GPS 20 is used due to its accuracy, it is contemplated that other systems that provide location services can be used. For instance, access to local communication systems can be used in order to establish an approximate location of the wearable device 10.

When a user of the emergency system 100 hits a trigger, a signal is transmitted to a monitoring station 40. The signal preferably has positional information and information related to the identity of the person that the wearable device 10 is associated with. The monitoring station 40 uses the information related to the identity of the person in order to access a database 30. The database 30 may contain identification information, as well a medical information related to the individual. This information can be used to assist the individual as need be.

In an embodiment the monitoring station 40 is able to access emergency services that are located proximate to the where the wearable device 10 is located. This can enable immediate responses by emergency services in different locales. In an embodiment, the wearable device 10 can determine information regarding the heart rate of the user and is able to transmit that data. In an embodiment, the wearable device 10 can determine information regarding the respiratory rate of the user and is able to transmit that data. In an embodiment, the wearable device 10 can determine information regarding insulin levels of the user and is able to transmit that data. In an embodiment, the wearable device 10 can determine information regarding body temperature of the user and is able to transmit that data. In an embodiment, the wearable device 10 can determine information regarding the individuals proximate to the user and is able to transmit that data. In an embodiment, the wearable device 10 can determine information regarding the cell phone usage in the vicinity of the user and is able to transmit that data. In an embodiment, the wearable device 10 can capture visual images and is able to transmit that data. In an embodiment, the wearable device 10 can capture audio information and is able to transmit that data.

All of the information gathered in response to the activation of the device is able to be used in order to provide more security to the user of the wearable device. In an embodiment, the wearable device 10 is able to be activated without the need for first triggering the device and is able to transmit a signal in response to one of the physical scenarios discussed above. In an embodiment, the wearable device 10 can determine from environmental circumstances that the monitoring station 40 should be contacted. In an embodiment, predetermined boundaries can be established and a signal transmitted in response to the wearable device 10 moving outside those predetermined boundaries. In an embodiment, the wearable device 10 can be triggered when proximate to a device or to a location that is associated with known criminals or registered offenders, for example by determining a known registered cell phone is in the area.

In an embodiment, the wearable device 10 can interact with an application that may be downloaded onto the wearable device 10, phones, computers, and other computer interactive devices. In an embodiment, the application is able to provide one touch connection to a local emergency services center to provide them with positioning data, information regarding the user, such as a child, and their photographs. In an embodiment, the location of the user, such as a child, can be provided as part of map application. In an embodiment, parents can send a direct voice message to a child via the application dashboard. In an embodiment, alerts are automatically sent to members of safety networks, such as family and/or friends. In an embodiment, heart rate readings are provided. In an embodiment, many people can serve as members of a safety network that can be notified in addition to or instead of an emergency services network. In an embodiment, the battery level of the wearable device 10 can be provided to the members of the family and/or friends safety network.

The device for tracking and providing information to emergency services for children, adults, and disabled individuals is an innovative and valuable invention. It can save lives by enabling emergency services to quickly locate and aid individuals in need. The device's GPS tracking system, wireless communication system, and database for storing personal information make it a comprehensive solution for emergency situations.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

What is claimed is:

1. An emergency system comprising:
a wearable device, the wearable device comprising;
a global positioning system for determining the position of the wearable device;
a trigger that is adapted to transmit a signal, the signal comprising at least the position of the wearable device and an identity associated with the wearable device;
a monitoring station adapted to receive the transmitted signal, the signal transmitted containing the identity associated with the wearable device; and
a database accessible by the monitoring station wherein the database has data related to the identity associated with the wearable device and information related to emergency services located near the position of the wearable device, the database further adapted to contact emergency services in response to the received transmitted signal.

2. The emergency system of claim 1, wherein the database further comprises medical records.

3. The emergency system of claim 1, wherein the wearable device is adapted to determine physical conditions of a user of the wearable device.

4. The emergency system of claim 3, wherein the physical condition is a hear rate.

5. The emergency system of claim 3, wherein the physical condition is breathing rate.

6. The emergency system of claim 3, wherein the physical condition is insulin level.

7. The emergency system of claim 1, wherein the wearable device is adapted to transmit a signal using satellite services.

8. The emergency system of claim 1, wherein the wearable device is adapted to capture visual images in response to activating the trigger.

9. The emergency system of claim 1, wherein the wearable device is adapted to capture audio in response to activating the trigger.

10. The emergency system of claim 1, wherein the wearable device is adapted to send a signal indicating that nearby cell phone data be captured in response to activating the trigger.

11. An emergency device comprising:
a global positioning system for determining the position of the wearable device; and
a trigger that is adapted to transmit a signal, the signal comprising at least the position of the wearable device and an identity associated with the wearable device, wherein when the signal is received by a monitoring station adapted to receive the transmitted signal, a database is accessed by the monitoring station wherein the database has data related to the identity associated with the wearable device and information related to emergency services located near the position of the wearable device, the database further adapted to contact emergency services in response to the received transmitted signal.

12. The emergency device of claim 11, wherein medical records are accessible by the database.

13. The emergency device of claim 11, wherein the wearable device is adapted to determine physical conditions of a user of the wearable device.

14. The emergency device of claim 13, wherein the physical condition is a hear rate.

15. The emergency device of claim 13, wherein the physical condition is breathing rate.

16. The emergency device of claim 13, wherein the physical condition is insulin level.

17. The emergency device of claim 11, wherein the wearable device is adapted to transmit a signal using satellite services.

18. The emergency device of claim 11, wherein the wearable device is adapted to capture visual images in response to activating the trigger.

19. The emergency device of claim 11, wherein the wearable device is adapted to capture audio in response to activating the trigger.

20. The emergency device of claim 11, wherein the wearable device is adapted to send a signal indicating that nearby cell phone data be captured in response to activating the trigger.
